(19) United States
(12) Patent Application Publication
(10) Pub. No.: US 2008/0199098 A1
(43) Pub. Date: Aug. 21, 2008

(54) Information processing method, information processing apparatus, and storage medium having program stored thereon

(75) Inventors: Tsuneo Kasai, Azumino-shi (JP); Naoki Kuwata, Shiojiri-shi (JP); Hirokazu Kasahara, Okaya-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/033,838

(22) Filed: Feb. 19, 2008

(30) Foreign Application Priority Data
Feb. 19, 2007 (JP) 2007-038370
Dec. 5, 2007 (JP) 2007-315246

(51) Int. Cl. G06K 9/40

(52) U.S. Cl. 382/254

(57) ABSTRACT

An information processing method includes: obtaining, from image data, data indicating a characteristic of an image indicated by the image data; obtaining, from supplemental data appended to the image data, data other than data relating to a scene; and identifying a scene of the image with data indicating the characteristic of the image and the data other than data relating to the scene as characteristic amounts.

### CROSS-REFERENCE TO RELATED APPLICATIONS

The present application claims priority upon Japanese Patent Application No. 2007-038370 filed on Feb. 19, 2007 and Japanese Patent Application No. 2007-315246 filed on Dec. 5, 2007, which are herein incorporated by reference.

### BACKGROUND

1. Technical Field

The present invention relates to information processing methods, information processing apparatuses, and storage media having programs stored thereon.

2. Related Art

Some digital still cameras have mode setting dials for setting the shooting mode. When the user sets a shooting mode using the dial, the digital still camera determines shooting conditions (such as exposure time) according to the shooting mode and takes a picture. When the picture is taken, the digital still camera generates an image file. This image file contains image data about an image photographed and supplemental data about, for example, the shooting conditions when photographing the image, which is appended to the image data.

On the other hand, subjecting the image data to image processing according to the supplemental data has also been practiced. For example, when a printer performs printing based on the image file, the image data is corrected according to the shooting conditions indicated by the supplemental data and printing is performed in accordance with the corrected image data. JP-A-2001-238177 describes an example of a background art.

There are instances where the user forgets to set the shooting mode and thus a picture is taken while a shooting mode unsuitable for the shooting conditions remains set. For example, a daytime scene may be photographed with the night scene mode being set. This results in a situation in which data indicating the night scene mode is stored in the supplemental data although the image data in the image file is an image of the daytime scene. In such a situation, when the image indicated by image data is identified in accordance with the night scene mode indicated by the supplemental data, the probability of misidentification becomes high. Such misidentification is caused not only by improper dial setting but also by a mismatch between the contents of the image data and the contents of the supplemental data.

### SUMMARY

The present invention has been devised in light of these circumstances and it is an advantage thereof to decrease a probability of misidentification.

In order to achieve the above-described advantage, a primary aspect of the invention is an information processing method including: obtaining, from image data, data indicating a characteristic of an image indicated by the image data; obtaining, from supplemental data appended to the image data, data other than data relating to a scene; and identifying a scene of the image with data indicating the characteristic of the image and the data other than data relating to the scene as characteristic amounts.

Other features of the invention will become clear through the explanation in the present specification and the description of the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is an explanatory diagram of an image processing system;

FIG. 2 is an explanatory diagram of a configuration of a printer;

FIG. 3 is an explanatory diagram of a structure of an image file;

FIG. 4A is an explanatory diagram of tags used in IFD0; FIG. 4B is an explanatory diagram of tags used in Exif SubIFD;

FIG. 5 is a correspondence table that shows the correspondence between the settings of a mode setting dial and data;

FIG. 6 is an explanatory diagram of an automatic correction function of the printer;

FIG. 7 is an explanatory diagram of the relationship between scenes of images and correction details;

FIG. 8 is a flow diagram of scene identification processing by a scene identification section;

FIG. 9 is an explanatory diagram of functions of the scene identification section;

FIG. 10 is a flow diagram of overall identification processing;

FIG. 11 is an explanatory diagram of an identification target table;

FIG. 12 is an explanatory diagram of a positive threshold in the overall identification processing;

FIG. 13 is an explanatory diagram of Recall and Precision;

FIG. 14 is an explanatory diagram of a first negative threshold;

FIG. 15 is an explanatory diagram of a second negative threshold;

FIG. 16A is an explanatory diagram of thresholds in a landscape identifying section; FIG. 16B is an explanatory diagram of an outline of processing with the landscape identifying section;

FIG. 17 is a flow diagram of partial identification processing;

FIG. 18 is an explanatory diagram of the order in which partial images are selected by an evening partial identifying section;

FIG. 19 shows graphs of Recall and Precision when an evening scene image is identified using only the top-ten partial images;

FIG. 20A is an explanatory diagram of discrimination using a linear support vector machine; FIG. 20B is an explanatory diagram of discrimination using a kernel function; and

FIG. 21 is a flow diagram of integrative identification processing.

### DESCRIPTION OF EXEMPLARY EMBODIMENTS

At least the following matters will be made clear by the explanation in the present specification and the description of the accompanying drawings.

An information processing method including obtaining, from image data, data indicating a characteristic of an image indicated by the image data; obtaining, from supplemental data appended to the image data, data other than data relating to a scene; and identifying a scene of the image with data indicating the characteristic of the image and the data other than data relating to the scene as characteristic amounts will be made clear.

With this information processing method, the probability of misidentification can be decreased.

Moreover, it is preferable that the data other than data relating to the scene is control data of a picture-taking apparatus when generating the image data. In particular, it is preferable that the control data is data relating to brightness of the image. Further, it is preferable that the control data is data relating to a color of the image. With this configuration, the percentage of misidentification can be decreased.

Moreover, it is preferable that obtaining data indicating the characteristic of the image includes acquiring data indicating the characteristic of the entire image and data indicating characteristics of partial images included in the image, identifying the scene includes entire identification of identifying the scene of the image indicated by the image data, using data indicating the characteristic of the entire image, and partial identification of identifying the scene of the image indicated by the image data, using data indicating the characteristics of the partial images, when the scene of the image cannot be identified in the entire identification, the partial identification is performed, and the scene of the image can be identified in the entire identification, the partial identification is not performed. With this configuration, the processing speed can be increased.

Moreover, it is preferable that the entire identification includes an evaluation value according to a probability that the image is a predetermined scene, using data indicating the characteristic of the entire image, and the evaluation value is larger than a first threshold, identifying the image as the predetermined scene, the partial identification includes identifying the image as the predetermined scene, using data indicating the characteristics of the partial images, and when the evaluation value in the entire identification is smaller than a second threshold, the partial identification is not performed. With this configuration, the processing speed can be increased.

Moreover, it is preferable that identifying the scene includes first scene identification of identifying that the image is a first scene based on the characteristic amounts, and a second scene identification of identifying that the image is a second scene different from the first scene based on the characteristic amounts, the first scene identification includes calculating an evaluation value according to a probability that the image is the first scene based on the characteristic amounts, and the evaluation value is larger than a first threshold, identifying the image as the first scene, in identifying the scene, the evaluation value in the first identification is larger than a third threshold, the second scene identification is not performed. With this configuration, the processing speed can be increased.

Moreover, an information processing apparatus including: a first obtaining section that obtains, from image data, data indicating a characteristic of an image indicated by the image data; a second obtaining section that obtains, from supplemental data appended to the image data, data other than data relating to a scene; and an identifying section that identifies the scene of the image with data indicating the characteristic of the image and the data other than data relating to the scene as characteristic amounts will be made clear.

Moreover, a program including: code for making an information processing apparatus obtain, from image data, data indicating a characteristic of an image indicated by the image data; for making an information processing apparatus obtain, from supplemental data appended to image data, data other than data relating to a scene; and for making an information processing device identify a scene of the image with data indicating a characteristic of the image and the data other than data relating to the scene as characteristic amounts will be made clear.

Overall Configuration

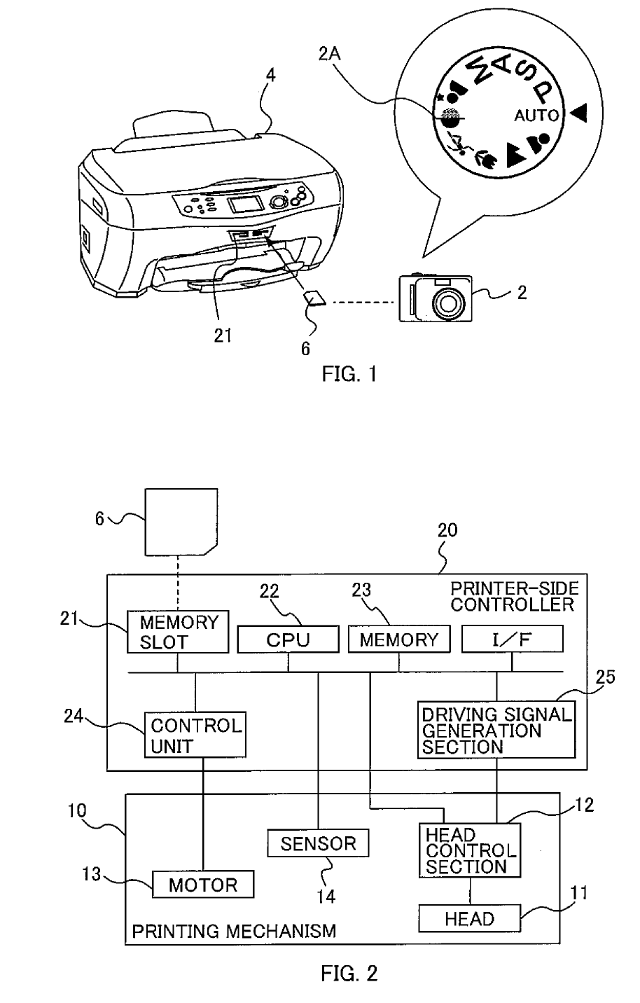

FIG. 1 is an explanatory diagram of an image processing system. This image processing system includes a digital still camera 2 and a printer 4.

The digital still camera 2 is a camera that captures a digital image by forming an image of a subject onto a digital device (such as a CCD) The digital still camera 2 is provided with a mode setting dial 2A. The user can set a shooting mode according to the shooting conditions using the dial 2A. For example, when the “night scene” mode is set with the dial 2A, the digital still camera 2 makes the shutter speed long or increases the ISO sensitivity to take a picture with shooting conditions suitable for photographing a night scene.

The digital still camera 2 saves an image file, which has been generated by taking a picture, on a memory card 6 in conformity with the file format standard. The image file contains not only digital data (image data) about an image photographed but also supplemental data about, for example, the shooting conditions (shooting data) at the time when the image was photographed.

The printer 4 is a printing apparatus for printing the image represented by the image data on paper. The printer 4 is provided with a slot 21 into which the memory card 6 is inserted. After taking a picture with the digital still camera 2, the user can remove the memory card 6 from the digital still camera 2 and insert the memory card 6 into the slot 21.

FIG. 2 is an explanatory diagram of a configuration of the printer 4. The printer 4 includes a printing mechanism 10 and a printer-side controller 20 for controlling the printing mechanism 10. The printing mechanism 10 has a head 11 for ejecting ink, a head control section 12 for controlling the head 11, a motor 13 for, for example, transporting paper, and a sensor 14. The printer-side controller 20 has the memory slot 21 for sending/receiving data to/from the memory card 6, a CPU 22, a memory 23, a control unit 24 for controlling the motor 13, and a driving signal generation section 25 for generating driving signals (driving waveforms).

When the memory card 6 is inserted into the slot 21, the printer-side controller 20 reads out the image file saved on the memory card 6 and stores the image file in the memory 23. Then, the printer-side controller 20 converts image data in the image file into print data to be printed by the printing mechanism 10 and controls the printing mechanism 10 based on the print data to print the image on paper. A sequence of these operations is called “direct printing.”

It should be noted that “direct printing” not only is performed by inserting the memory card 6 into the slot 21, but also can be performed by connecting the digital still camera 2 to the printer 4 via a cable (not shown).

Structure of Image File

An image file is constituted by image data and supplemental data. The image data is constituted by a plurality of units of pixel data. The pixel data is data indicating color information (tone value) of each pixel. An image is made up of pixels arranged in a matrix form. Accordingly, the image data is data representing an image. The supplemental data includes data indicating the properties of the image data, shooting data, thumbnail image data, and the like.

Hereinafter, a specific structure of an image file is described.

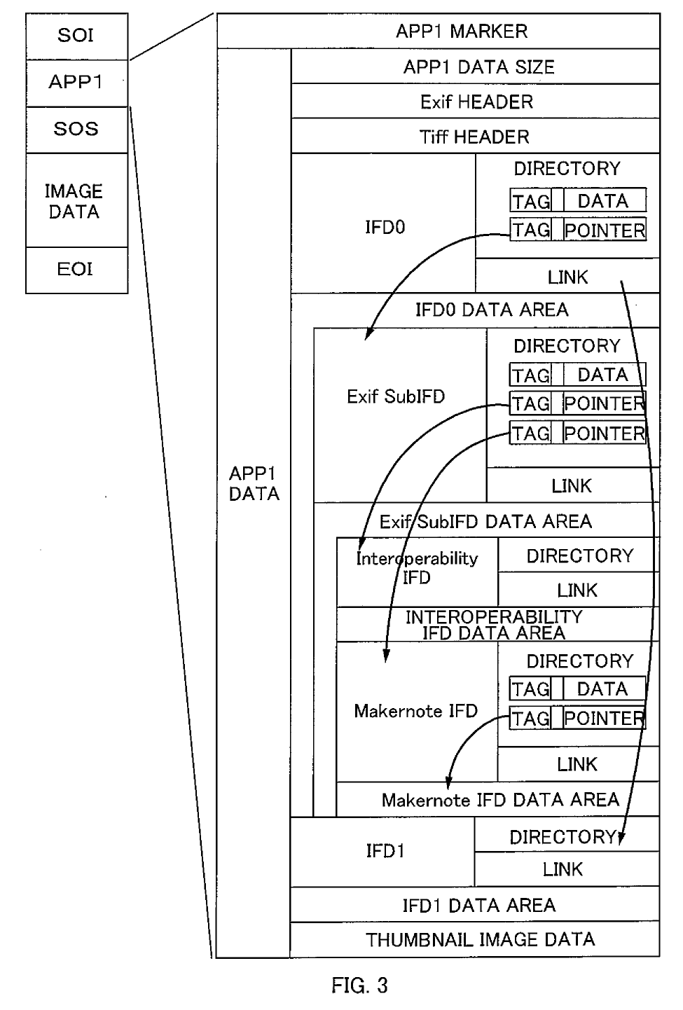

FIG. 3 is an explanatory diagram of the structure of the image file. An overall configuration of the image file is shown in the left side of the diagram, and a configuration of an APP1 segment is shown in the right side of the diagram.

The image file begins with a marker indicating SOI (Start of image) and ends with a marker indicating EOI (End of image). The marker indicating SOI is followed by an APP1 marker indicating the start of a data area of APP1. The data area of APP1 after the APP1 marker contains supplemental data, such as shooting data and a thumbnail image. Moreover, image data is included after a marker indicating SOS (Start of Stream).

After the APP1 marker, information indicating the size of the data area of APP1 is placed, which is followed by an EXIF header, a TIFF header, and then IFD areas.

Every IFD area has a plurality of directory entries, a link indicating the location of the next IFD area, and a data area. For example, the first IFD, IFD0 (IFD of main image), links to the location of the next IFD, IFD1 (IFD of thumbnail image). However, there is no IFD next to the IFD1 here, so that the IFD1 does not link to any other IFDs. Every directory entry contains a tag and a data section. When a small amount of data is to be stored, the data section stores actual data as it is, whereas when a large amount of data is to be stored, actual data is stored in an IFD0 data area and the data section stores a pointer indicating the storage location of the data. It should be noted that the IFD0 contains a directory entry in which a tag (Exit IFD Pointer), meaning the storage location of an Exif SubIFD, and a pointer (offset value), indicating the storage location of the Exif SubIFD, are stored.

The Exit SubIFD area has a plurality of directory entries. These directory entries also contain a tag and a data section. When a small amount of data is to be stored, the data section stores actual data as it is, whereas when a large amount of data is to be stored, actual data is stored in an Exif SubIFD data area and the data section stores a pointer indicating the storage location of the data. It should be noted that the Exif SubIFD stores a tag meaning the storage location of a Makernote IFD and a pointer indicating the storage location of the Makernote IFD.

The Makernote IFD area has a plurality of directory entries. These directory entries also contain a tag and a data section. When a small amount of data is to be stored, the data section stores actual data as it is, whereas when a large amount of data is to be stored, actual data is stored in a Makernote IFD data area and the data section stores a pointer indicating the storage location of the data. However, regarding the Makernote IFD area, the data storage format can be defined freely, so that data is not necessarily stored in this format. In the following description, data stored in the Makernote IFD area is referred to as “MakerNote data.”

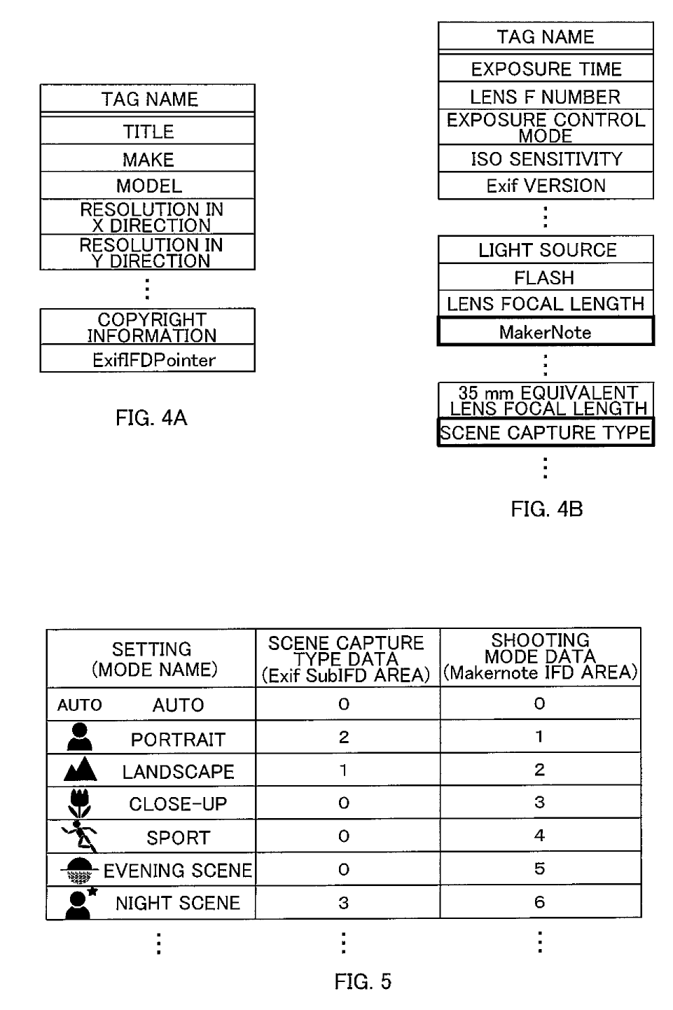

FIG. 4A is an explanatory diagram of tags used in the IFD0. As shown in the diagram, the IFD0 stores general data (data indicating the properties of the image data) and no detailed shooting data.

FIG. 4B is an explanatory diagram of tags used in the Exif SubIFD. As shown in the diagram, the Exif SubIFD stores detailed shooting data. It should be noted that most of shooting data that is extracted during scene identification processing is the shooting data stored in the Exif SubIFD. The scene capture type tag (Scene Capture Type) is a tag indicating the type of a scene photographed. Moreover, the Makernote tag is a tag indicating the storage location of the Makernote IFD.

When a data section (scene capture type data) corresponding to the scene capture type tag in the Exif SubIFD is “zero,” it means “Normal,” “1” means “landscape,” “2” means “portrait,” and “3” means “night scene.” It should be noted that since data stored in the Exif SubIFD is standardized, anyone can know the contents of this scene capture type data.

In the present embodiment, the MakerNote data includes shooting mode data. This shooting mode data indicates different values corresponding to different modes set with the mode setting dial 2A. However, since the format of the MakerNote data varies from manufacturer to manufacturer, it is impossible to know the contents of the shooting mode data unless knowing the format of the MakerNote data.

FIG. 5 is a correspondence table that shows the correspondence between the settings of the mode setting dial 2A and the data. The scene capture type tag used in the Exif SubIFD is in conformity with the file format standard, so that scenes that can be specified are limited, and thus data specifying scenes such as “evening scene” cannot be stored in a data section. On the other hand, the MakerNote data can be defined freely, so that data specifying the shooting mode of the mode setting dial 2A can be stored in a data section using a shooting mode tag, which is included in the MakerNote data.

After taking a picture with shooting conditions according to the setting of the mode setting dial 2A, the above-described digital still camera 2 creates an image file such as described above and saves the image file on the memory card 6. This image file contains the scene capture type data and the shooting mode data according to the mode setting dial 2A, which are stored in the Exif SubIFD and the Makernote IFD, respectively, as scene information appended to the image data.

Outline of Automatic Correction Function

When “portrait” pictures are printed, there is a demand for beautiful skin tones. Moreover, when “landscape” pictures are printed, there is a demand that the blue color of the sky should be emphasized and the green color of trees and plants should be emphasized. Thus, the printer 4 of the present embodiment has an automatic correction function of analyzing the image file and automatically performing appropriate correction processing.

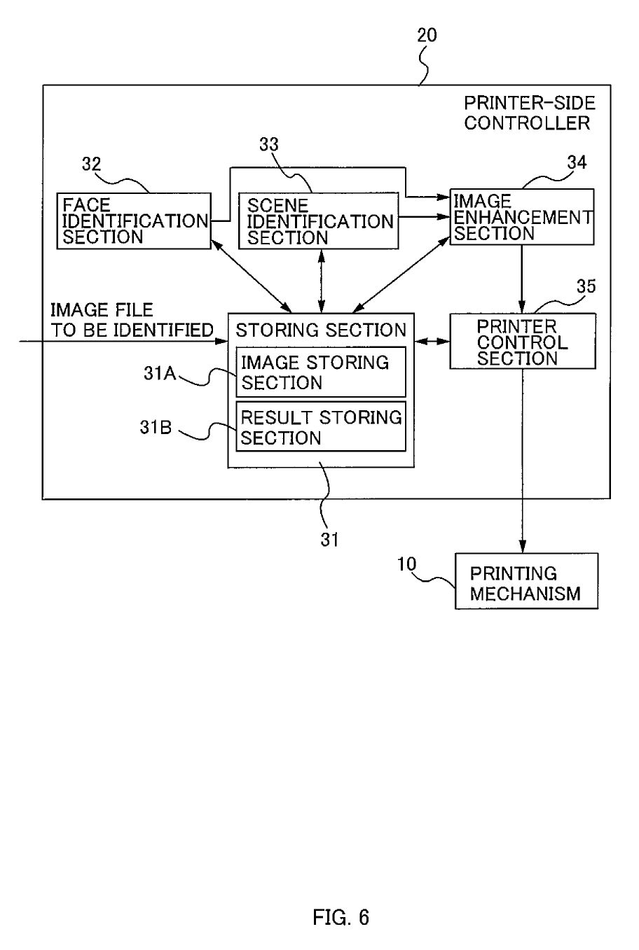

FIG. 6 is an explanatory diagram of the automatic correction function of the printer 4. Each component of the printer-side controller 20 in the diagram is realized with software and hardware.

A storing section 31 is realized with a certain area of the memory 23 and the CPU 22. All or a part of the image file that has been read out from the memory card 6 is expanded in an image storing section 31A of the storing section 31. The results of operations performed by the components of the printer-side controller 20 are stored in a result storing section 31B of the storing section 30.

A face identification section 32 is realized with the CPU 22 and a face identification program stored in the memory 23. The face identification section 32 analyzes the image data stored in the image storing section 31A and identifies whether or not there is a human face. When the face identification section 32 identifies that there is a human face, the image to be identified is identified as belonging to “portrait” scenes. In this case, a scene identification section 33 does not perform scene identification processing. Since the face identification processing performed by the face identification section 32 is similar to the processing that is already widespread, a detailed description thereof is omitted.

The scene identification section 33 is realized with the CPU 22 and a scene identification program stored in the memory 23. The scene identification section 33 analyzes the image file stored in the image storing section 31A and identifies the scene of the image represented by the image data. The scene identification section 33 performs the scene identification processing when the face identification section 32 identifies that there is no human face. As described later, the scene identification section 33 identifies which of “landscape,” “evening scene,” “night scene,” “flower,” “autumnal,” and “other” images the image to be identified is.

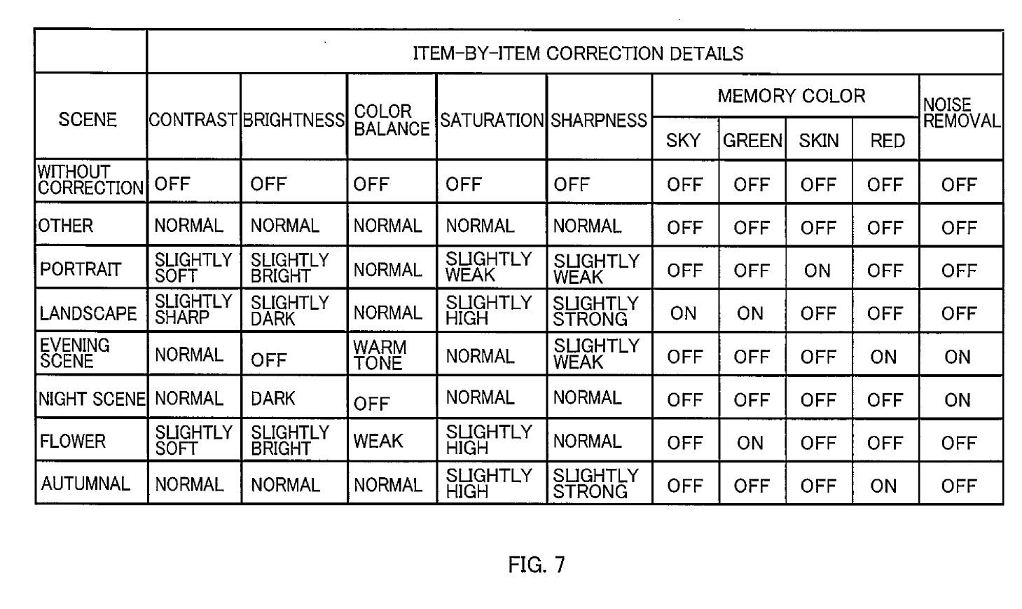

FIG. 7 is an explanatory diagram of the relationship between the scenes of images and correction details.

An image enhancement section 34 is realized with the CPU 22 and an image correction program stored in the memory 23. The image enhancement section 34 corrects the image data in the image storing section 31A based on the identification result (result of identification performed by the face identification section 32 or the scene identification section 33) that has been stored in the result storing section 31B of the storing section 31. For example, when the identification result of the scene identification section 33 is “landscape,” the image data is corrected so that blue and green are emphasized. It should be noted that the image enhancement section 34 may correct the image data not only based on the identification result about the scene but also reflecting the contents of the shooting data in the image file. For example, when negative exposure compensation was applied, the image data may be corrected so that a dark image is prevented from being brightened.

The printer control section 35 is realized with the CPU 22, the driving signal generation section 25, the control unit 24, and a printer control program stored in the memory 23. The printer control section 35 converts the corrected image data into print data and makes the printing mechanism 10 print the image.

Scene Identification Processing

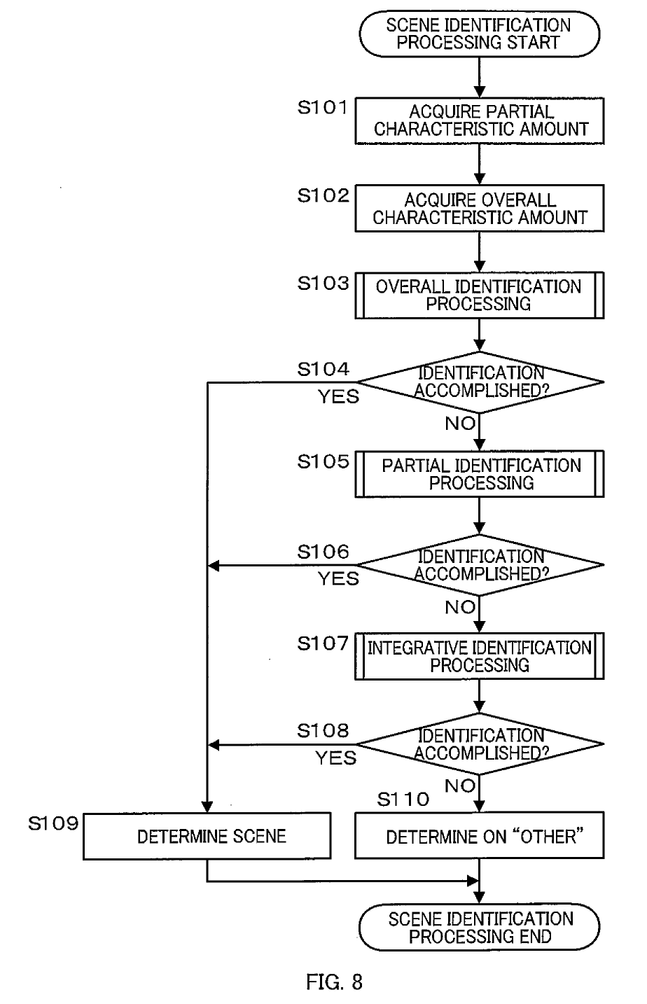

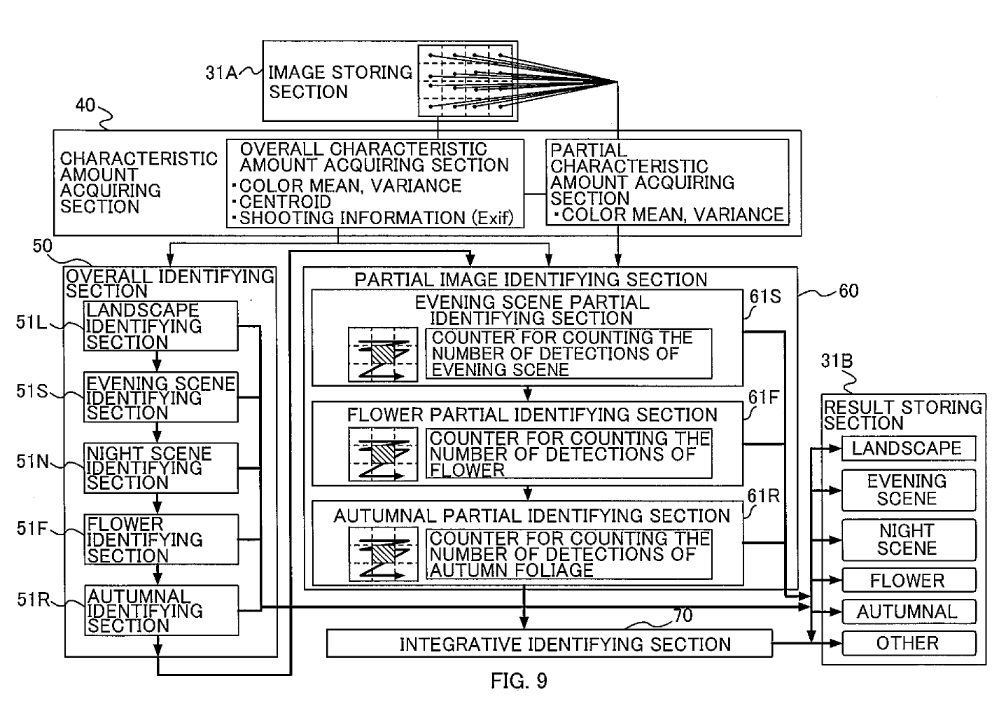

FIG. 8 is a flow diagram of the scene identification processing performed by the scene identification section 33. FIG. 9 is an explanatory diagram of functions of the scene identification section 33. Each component of the scene identification section 33 shown in the diagram is realized with software and hardware.

First, a characteristic amount acquiring section 40 analyzes the image data expanded in the image storing section 31A of the storing section 31 and acquires partial characteristic amounts (S101). Specifically, the characteristic amount acquiring section 40 divides the image data into 8×8=64 blocks, calculates color means and variances of the blocks, and acquires the calculated color means and variances as partial characteristic amounts. It should be noted that every pixel here has data about a tone value in the YCC color space, and a mean value of Y, a mean value of Cb, and a mean value of Cr are calculated for each block and a variance of Y, a variance of Cb, and a variance of Cr are calculated for each block. That is to say, three color means and three variances are calculated as partial characteristic amounts for each block. The calculated color means and variances indicate features of a partial image in each block. It should be noted that it is also possible to calculate mean values and variances in the RGB color space.

Since the color means and variances are calculated for each block, the characteristic amount acquiring section 40 expands portions of the image data corresponding to the respective blocks in a block-by-block order without expanding all of the image data in the image storing section 31A. For this reason, the image storing section 31A may not necessarily have as large a capacity as all of the image data can be expanded.

Next, the characteristic amount acquiring section 40 acquires overall characteristic amounts (S102). Specifically, the characteristic amount acquiring section 40 acquires color means and variances, a centroid, and shooting information of the entire image data as overall characteristic amounts. It should be noted that the color means and variances indicate features of the entire image. The color means, variances, and the centroid of the entire image data are calculated using the partial characteristic amounts acquired in advance. For this reason, it is not necessary to expand the image data again when calculating the overall characteristic amounts, and thus the speed at which the overall characteristic amounts are calculated is increased. It is because the calculation speed is increased in this manner that the overall characteristic amounts are obtained after the partial characteristic amounts although overall identification processing (described later) is performed before partial identification processing (described later). It should be noted that the shooting information is extracted from the shooting data in the image file. Specifically, information such as the aperture value, the shutter speed, and whether or not the flash is fired, is used as the overall characteristic amounts. However, not all of the shooting data in the image file is used as the overall characteristic amounts.

Next, an overall identifying section 50 performs the overall identification processing (S103). The overall identification processing is processing for identifying (estimating) the scene of the image represented by the image data based on the overall characteristic amounts. A detailed description of the overall identification processing is provided later.

When the scene can be identified by the overall identification processing (“YES” in S104), the scene identification section 33 determines the scene by storing the identification result in the result storing section 31B of the storing section 31 (S109) and terminates the scene identification processing. That is to say, when the scene can be identified by the overall identification processing (“YES” in S104), the partial identification processing and integrative identification processing are omitted. Thus, the speed of the scene identification processing is increased.

When the scene cannot be identified by the overall identification processing (“NO” in S104), a partial identifying section 60 then performs the partial identification processing (S105). The partial identification processing is processing for identifying the scene of the entire image represented by the image data based on the partial characteristic amounts. A detailed description of the partial identification processing is provided later.

When the scene can be identified by the partial identification processing (“YES” in S106), the scene identification section 33 determines the scene by storing the identification result in the result storing section 31B of the storing section 31 (S109) and terminates the scene identification processing. That is to say, when the scene can be identified by the partial identification processing (“YES” in S106), the integrative identification processing is omitted. Thus, the speed of the scene identification processing is increased.

When the scene cannot be identified by the partial identification processing (“NO” in S106), an integrative identifying section 70 performs the integrative identification processing (S107). A detailed description of the integrative identification processing is provided later.

When the scene can be identified by the integrative identification processing (“YES” in S108), the scene identification section 33 determines the scene by storing the identification result in the result storing section 31B of the sorting section 31 (S109) and terminates the scene identification processing. On the other hand, when the scene cannot be identified by the integrative identification processing (“NO” in S108), the identification result that the image represented by the image data is an “other” scene (scene other than “landscape,” “evening scene,” “night scene,” “flower,” or “autumnal”) is stored in the result storing section 31B (S110).

Overall Identification Processing

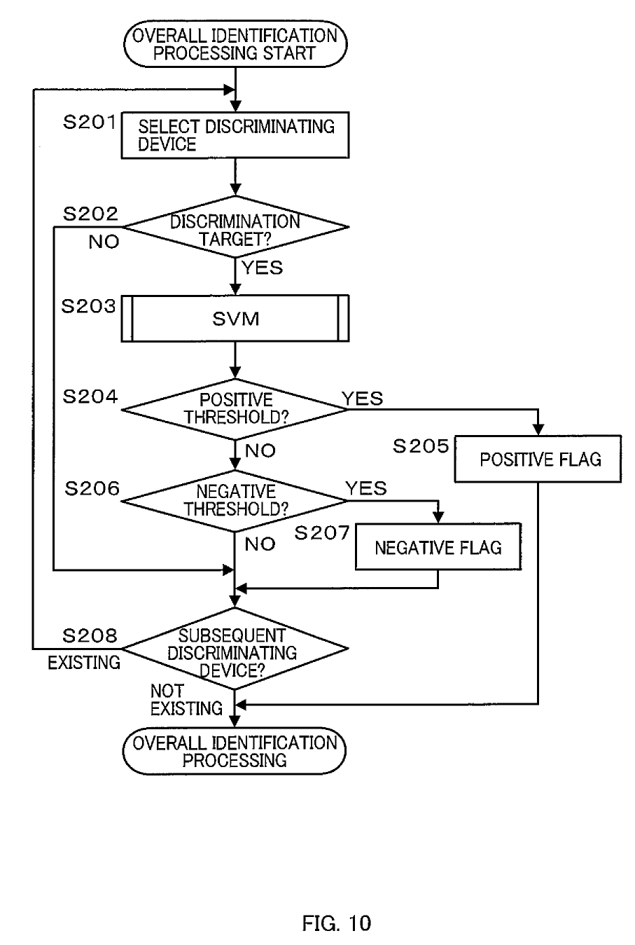

FIG. 10 is a flow diagram of the overall identification processing. Here, the overall identification processing is described also with reference to FIG. 9.

First, the overall identifying section 50 selects one sub-identifying section 51 from a plurality of sub-identifying sections 51 (S201). The overall identifying section 50 is provided with five sub-identifying sections 51 that identify whether or not the image serving as a target of identification (image to be identified) belongs to a specific scene. The five sub-identifying sections 51 identify landscape, evening scene, night scene, flower, and autumnal scenes, respectively. Here, the overall identifying section 50 selects the sub-identifying sections 51 in the order of landscape→evening scene→night scene→flower→autumnal. For this reason, at the start, the sub-identifying section 51 (landscape identifying section 51L) for identifying whether or not the image to be identified belongs to landscape scenes is selected.

Next, the overall identifying section 50 references an identification target table and determines whether or not to identify the scene using the selected sub-identifying section 51 (S202).

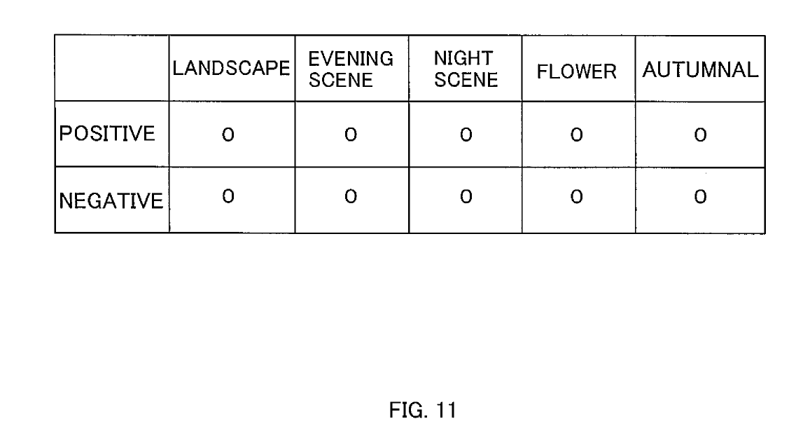

FIG. 11 is an explanatory diagram of the identification target table. This identification target table is stored in the result storing section 31B of the storing section 31. At the first stage, all the fields in the identification target table are set to zero. In the process of S202, a “negative” field is referenced, and when this field is zero, it is determined “YES,” and when this field is 1, it is determined “NO.” Here, the overall identifying section 51 references the “negative” field under the “landscape” column to find that this field is zero and thus determines “YES.”

Next, the sub-identifying section 51 calculates a value (evaluation value) according to the probability that the image to be identified belongs to a specific scene based on the overall characteristic amounts (S203). The sub-identifying sections 51 of the present embodiment employ an identification method using a support vector machine (SVM). A description of the support vector machine is provided later. When the image to be identified belongs to a specific scene, the discriminant equation of the sub-identifying section 51 is likely to be a positive value. When the image to be identified does not belong to a specific scene, the discriminant equation of the sub-identifying section 51 is likely to be a negative value. Moreover, the higher the probability that the image to be identified belongs to a specific scene is, the larger the value of the discriminant equation is. Accordingly, a large value of the discriminant equation indicates a high probability that the image to be identified belongs to a specific scene, and a small value of the discriminant equation indicates a low probability that the image to be identified belongs to a specific scene.

Therefore, the value (evaluation value) of the discriminant equation indicates a certainty factor, i.e., the degree to which it is probable that the image to be identified belongs to a specific scene. It should be noted that the term “certainty factor” as used in the following description may refer to the value itself of the discriminant equation or to a precision ratio (described later) that can be obtained from the value of the discriminant equation. The value itself of the discriminant equation or the precision ratio (described later) that can be obtained from the value of the discriminant equation is also an “evaluation value” (evaluation result) according to the probability that the image to be identified belongs to a specific scene.

Next, the sub-identifying section 51 determines whether or not the value of the discriminant equation (the certainty factor) is larger than a positive threshold (S204). When the value of the discriminant equation is larger than the positive threshold, the sub-identifying section 51 determines that the image to be identified belongs to a specific scene.

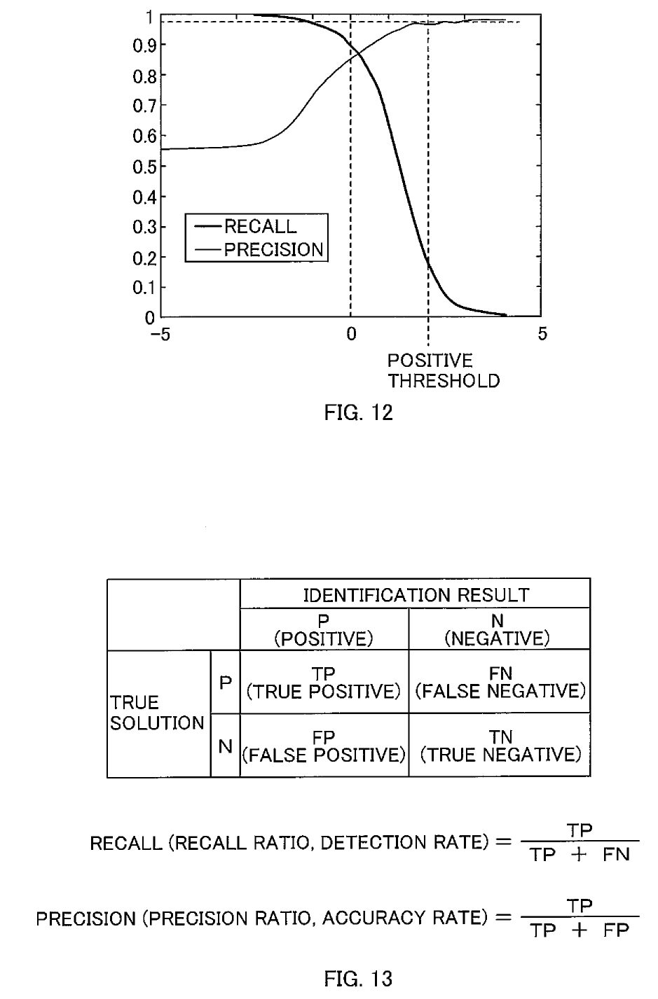

FIG. 12 is an explanatory diagram of the positive threshold in the overall identification processing. In this diagram, the vertical axis represents the positive threshold, and the horizontal axis represents the probability of Recall or Precision. FIG. 13 is an explanatory diagram of Recall and Precision. When the value of the discriminant equation is equal to or more than the positive threshold, the identification result is taken as Positive, and when the value of the discriminant equation is not equal to or more than the positive threshold, the identification result is taken as Negative.

Recall indicates the recall ratio or a detection rate. Recall is the proportion of the number of images identified as belonging to a specific scene in the total number of images of the specific scene. In other words, Recall indicates the probability that, when the sub-identifying section 51 is made to identify an image of a specific scene, the sub-identifying section 51 identifies Positive (the probability that the image of the specific scene is identified as belonging to the specific scene). For example, Recall indicates the probability that, when the landscape identifying section 51L is made to identify a landscape image, the landscape identifying section 51L identifies the image as belonging to landscape scenes.

Precision indicates the precision ratio or an accuracy rate. Precision is the proportion of the number of images of a specific scene in the total number of images identified as Positive. In other words, Precision indicates the probability that, when the sub-identifying section 51 for identifying a specific scene identifies an image as Positive, the image to be identified is the specific scene. For example, Precision indicates the probability that, when the landscape identifying section 51L identifies an image as belonging to landscape scenes, the identified image is actually a landscape image.

As can be seen from FIG. 12, the larger the positive threshold is, the greater Precision is. Thus, the larger the positive threshold is, the higher the probability that an image identified as belonging to, for example, landscape scenes is a landscape image is. That is to say, the larger the positive threshold is, the lower the probability of misidentification is.

On the other hand, the larger the positive threshold is, the smaller Recall is. As a result, for example, even when a landscape image is identified by the landscape identifying section 51L, it is difficult to correctly identify the image as belonging to landscape scenes. When the image to be identified can be identified as belonging to landscape scenes (“YES” in S204), identification with respect to the other scenes (such as evening scenes) is no longer performed, and thus the speed of the overall identification processing is increased. Therefore, the larger the positive threshold is, the lower the speed of the overall identification processing is. Moreover, since the speed of the scene identification processing is increased by omitting the partial identification processing when scene identification can be accomplished by the overall identification processing (S104), the larger the positive threshold is, the lower the speed of the scene identification processing is.

That is to say, too small a positive threshold will result in a high probability of misidentification, and too large a positive threshold will result in a decreased processing speed. In the present embodiment, the positive threshold for landscapes is set to 1.72 in order to set the precision ratio (Precision) to 97.5%.

When the value of the discriminant equation is larger than the positive threshold (“YES” in S204), the sub-identifying section 51 determines that the image to be identified belongs to a specific scene, and sets a positive flag (S205). “Set a positive flag” refers to setting a “positive” field in FIG. 11 to 1. In this case, the overall identifying section 50 terminates the overall identification processing without performing identification by the subsequent sub-identifying sections 51. For example, when an image can be identified as a landscape image, the overall identifying section 50 terminates the overall identification processing without performing identification with respect to evening scenes and the like. In this case, the speed of the overall identification processing can be increased because identification by the subsequent sub-identifying sections 51 is omitted.

When the value of the discriminant equation is not larger than the positive threshold (“No” in S204), the sub-identifying section 51 cannot determine that the image to be identified belongs to a specific scene, and performs the subsequent process of S206.

Then, the sub-identifying section 51 compares the value of the discriminant equation with a negative threshold (S206). Based on this comparison, the sub-identifying section 51 determines whether or not the image to be identified belongs to a predetermined scene. Such a determination is made in two ways. First, when the value of the discriminant equation of the sub-identifying section 51 with respect to a certain specific scene is smaller than a first negative threshold, it is determined that the image to be identified does not belong to that specific scene. For example, when the value of the discriminant equation of the landscape identifying section 51L is smaller than the first negative threshold, it is determined that the image to be identified does not belong to landscape scenes. Second, when the value of the discriminant equation of the sub-identifying section 51 with respect to a certain specific scene is larger than a second negative threshold, it is determined that the image to be determined does not belong to a scene different from that specific scene. For example, when the value of the discriminant equation of the landscape identifying section 51L is larger than the second negative threshold, it is determined that the image to be identified does not belong to night scenes.

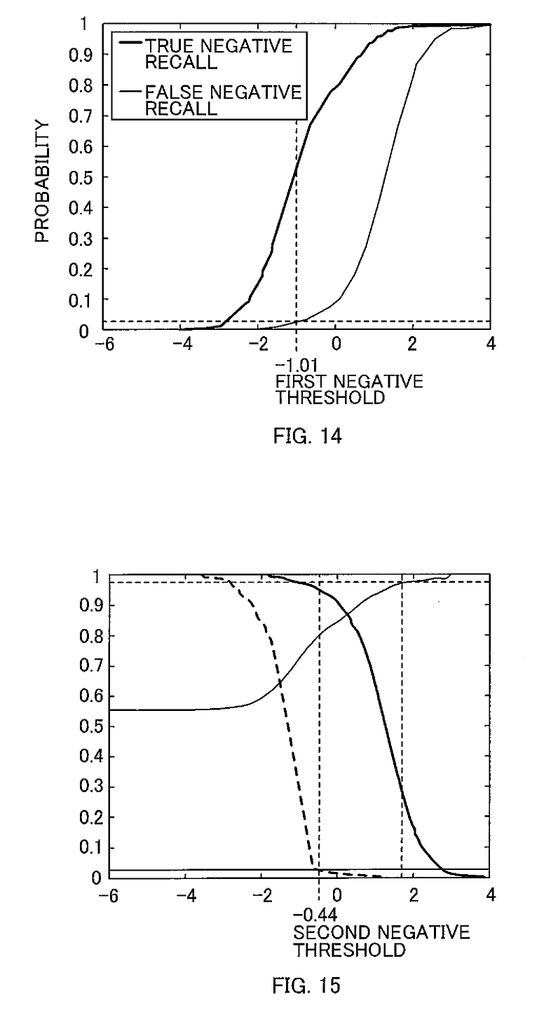

FIG. 14 is an explanatory diagram of the first negative threshold. In this diagram, the horizontal axis represents the first negative threshold, and the vertical axis represents the probability. The graph shown by a bold line represents True Negative Recall and indicates the probability that an image that is not a landscape image is correctly identified as not being a landscape image. The graph shown by a thin line represents False Negative Recall and indicates the probability that a landscape image is misidentified as not being a landscape image.

As can be seen from FIG. 14, the smaller the first negative threshold is, the smaller False Negative Recall is. Thus, the smaller the first negative threshold is, the lower the probability that an image identified as not belonging to, for example, landscape scenes is actually a landscape image becomes. In other words, the probability of misidentification decreases.

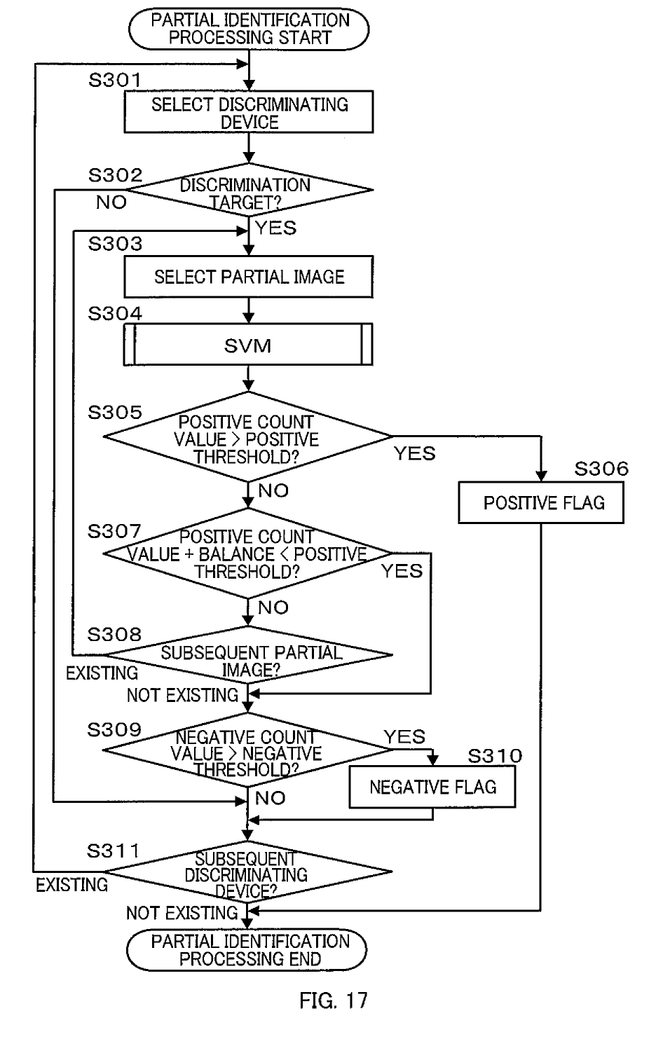

On the other hand, the smaller the first negative threshold is, the smaller True Negative Recall also is. As a result, an image that is not a landscape image is less likely to be identified as a landscape image. Meanwhile, when the image to be identified can be identified as not being a specific scene, processing by a sub-partial identifying section 61 with respect to that specific scene is omitted during the partial identification processing, thereby increasing the speed of the scene identification processing (described later, S302 in FIG. 17). Therefore, the smaller the first negative threshold is, the lower the speed of the scene identification processing is.

That is to say, too large a first negative threshold will result in a high probability of misidentification, and too small a first negative threshold will result in a decreased processing speed. In the present embodiment, the first negative threshold is set to −1.01 in order to set False Negative Recall to 2.5%.

When the probability that a certain image belongs to landscape scenes is high, the probability that this image belongs to night scenes is inevitably low. Thus, when the value of the discriminant equation of the landscape identifying section 51L is large, it may be possible to identify the image as not being a night scene. In order to perform such identification, the second negative threshold is provided.

FIG. 15 is an explanatory diagram of the second negative threshold. In this diagram, the horizontal axis represents the value of the discriminant equation with respect to landscapes, and the vertical axis represents the probability. This diagram shows, in addition to the graphs of Recall and Precision shown in FIG. 12, a graph of Recall with respect to night scenes, which is drawn by a dotted line. When looking at this graph drawn by the dotted line, it is found that when the value of the discriminant equation with respect to landscapes is larger than −0.44, the probability that the image to be identified is a night scene image is 2.5%. In other words, even when the image to be identified is identified as not being a night scene image while the value of the discriminant equation with respect to landscapes is larger than −0.44, the probability of misidentification is no more than 2.5%. In the present embodiment, the second negative threshold is therefore set to −0.44.

When the value of the discriminant equation is smaller than the first negative threshold or when the value of the discriminant equation is larger than the second negative threshold (“YES” in S206), the sub-identifying section 51 determines that the image to be identified does not belong to a predetermined scene, and sets a negative flag (S207). “Set a negative flag” refers to setting a “negative” field in FIG. 11 to 1. For example, when it is determined that the image to be identified does not belong to landscape scenes based on the first negative threshold, the “negative” field under the “landscape” column is set to 1. Moreover, when it is determined that the image to be identified does not belong to night scenes based on the second negative threshold, the “negative” field under the “night scene” column is set to 1.

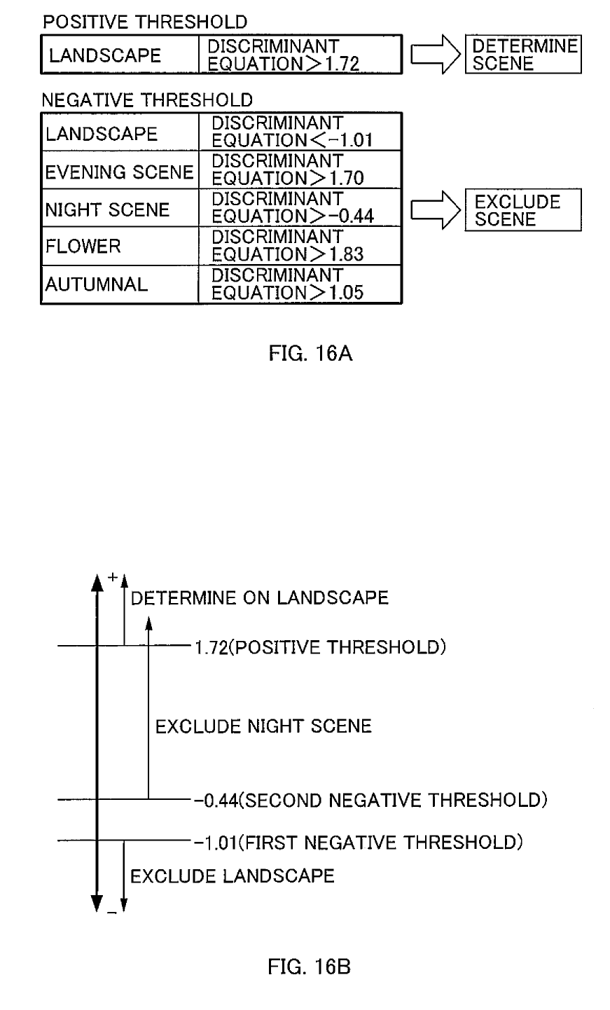

FIG. 16A is an explanatory diagram of the thresholds in the landscape identifying section 51L described above. In the landscape identifying section 51L, a positive threshold and a negative threshold are set in advance. The positive threshold is set to 1.72. The negative threshold includes a first negative threshold and second negative thresholds. The first negative threshold is set to −1.01. The second negative thresholds are set for scenes other than landscapes to respective values.

FIG. 16B is an explanatory diagram of an outline of the processing by the landscape identifying section 51L described above. Here, for the sake of simplicity of description, the second negative thresholds are described with respect to night scenes alone. When the value of the discriminant equation is larger than 1.72 (“YES” in S204), the landscape identifying section 51L determines that the image to be identified belongs to landscape scenes. When the value of the discriminant equation is not larger than 1.72 (“NO” in S204) and larger than −0.44 (“YES” in S206), the landscape identifying section 51L determines that the image to be identified does not belong to night scenes. When the value of the discriminant equation is smaller than −1.01 (“YES” in S206), the landscape identifying section S51 determines that the image to be identified does not belong to landscape scenes. It should be noted that the landscape identifying section 51L also determines with respect to evening and autumn scenes whether the image to be identified does not belong to these scenes based on the second negative thresholds. However, since the second negative threshold with respect to flower is larger than the positive threshold, it is not possible for the landscape identifying section 51L to determine that the image to be identified does not belong to the flower scene.

When it is “NO” in S202, when it is “NO” in S206, or when the process of S207 is finished, the overall identifying section 50 determines whether or not there is a subsequent sub-identifying section 51 (S208). Here, the processing by the landscape identifying section 51L has been finished, so that the overall identifying section 50 determines in S208 that there is a subsequent sub-identifying section 51 (evening scene identifying section 51S).

Then when the process of S205 is finished (when it is determined that the image to be identified belongs to a specific scene) or when it is determined in S208 that there is no subsequent sub-identifying section 51 (when it cannot be determined that the image to be identified belongs to a specific scene), the overall identifying section 50 terminates the overall identification processing.

As already described above, when the overall identification processing is terminated, the scene identification section 33 determines whether or not scene identification can be accomplished by the overall identification processing (S104 in FIG. 8). At this time, the scene identification section 33 references the identification target table shown in FIG. 11 and determines whether or not there is 1 in the “positive” field.

When scene identification can be accomplished by the overall identification processing (“YES” in S104), the partial identification processing and the integrative identification processing are omitted. Thus, the speed of the scene identification processing is increased.

Partial Identification Processing

FIG. 17 is a flow diagram of the partial identification processing. The partial identification processing is performed when scene identification cannot be accomplished by the overall identification processing (“No” in S104 in FIG. 8). As described in the following, the partial identification processing is processing for identifying the scene of the entire image by individually identifying the scenes of partial images into which the image to be identified is divided. Here, the partial identification processing is described also with reference to FIG. 9.

First, the partial identifying section 60 selects one sub-partial identifying section 61 from a plurality of sub-partial identifying sections 61 (S301). The partial identifying section 60 is provided with three sub-partial identifying sections 61. Each of the sub-partial identifying sections 61 identifies whether or not the 8×8=64 blocks of partial images into which the image to be identified is divided belong to a specific scene. The three sub-partial identifying sections 61 here identify evening scenes, flower scenes, and autumnal scenes, respectively. The partial identifying section 60 selects the sub-partial identifying sections 61 in the order of evening scene→flower→autumnal. Thus, at the start, the sub-partial identifying section 61 (evening scene partial identifying section 61S) for identifying whether or not the partial images belong to evening scenes is selected.

Next, the partial identifying section 60 references the identification target table (FIG. 11) and determines whether or not scene identification is to be performed using the selected sub-partial identifying section 61 (S302). Here, the partial identifying section 60 references the “negative” field under the “evening scene” column in the identification target table, and determines “YES” when there is zero and “NO” when there is 1. It should be noted that when, during the overall identification processing, the evening scene identifying section 515 sets a negative flag based on the first negative threshold or another sub-identifying section 51 sets a negative flag based on the second negative threshold, it is determined “NO” in this step S302. If it is determined “NO”, the partial identification processing with respect to evening scenes is omitted, so that the speed of the partial identification processing is increased. However, for convenience of description, it is assumed that the determination result here is “YES.”

Next, the sub-partial identifying section 61 selects one partial image from the 8×8=64 blocks of partial images into which the image to be identified is divided (S303).

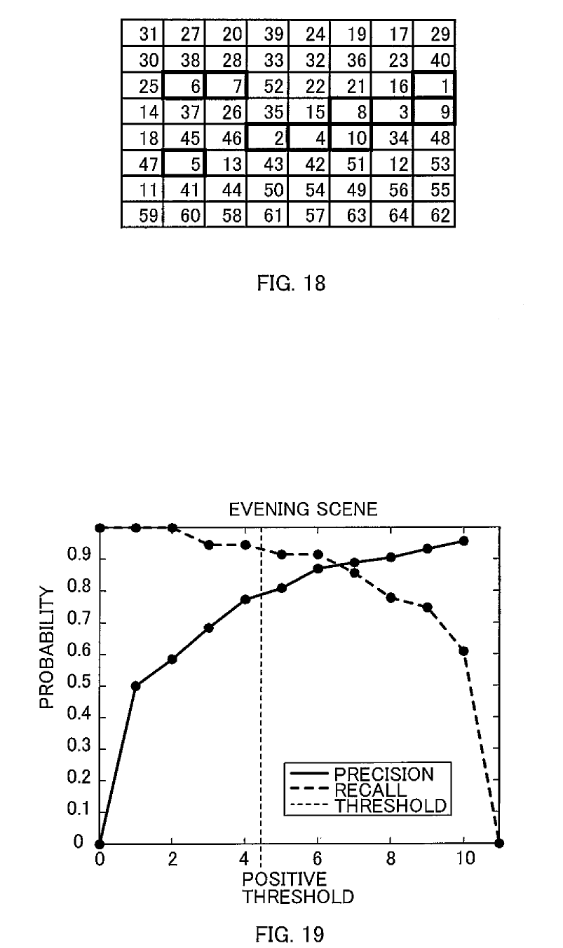

FIG. 18 is an explanatory diagram of the order in which the partial images are selected by the evening scene partial identifying section 61S. In a case where the scene of the entire image is identified based on partial images, it is preferable that the partial images used for identification are portions in which the subject is present. For this reason, in the present embodiment, several thousand sample evening scene images were prepared, each of the evening scene images was divided into 8×8=64 blocks, blocks containing a evening scene portion image (partial image of the sun and sky portion of a evening scene) were extracted, and based on the location of the extracted blocks, the probability that the evening scene portion image exists in each block was calculated. In the present embodiment, partial images are selected in descending order of the existence probability of the blocks. It should be noted that information about the selection sequence shown in the diagram is stored in the memory 23 as a part of the program.

It should be noted that in the case of an evening scene image, the sky of the evening scene often extends from around the center portion to the upper half portion of the image, so that the existence probability increases in blocks located in a region from around the center portion to the upper half portion. In addition, in the case of an evening scene image, the lower ⅓ portion of the image often becomes dark due to backlight and it is impossible to determine based on a single partial image whether the image is an evening scene or a night scene, so that the existence probability decreases in blocks located in the lower ⅓ portion. In the case of a flower image, the flower is often positioned around the center portion of the image, so that the probability that a flower portion image exists around the center portion increases.

Next, the sub-partial identifying section 61 determines, based on the partial characteristic amounts of a partial image that has been selected, whether or not the selected partial image belongs to a specific scene (S304). The sub-partial identifying sections 61 employ a discrimination method using a support vector machine (SVM), as is the case with the sub-identifying sections 51 of the overall identifying section 50. A description of the support vector machine is provided later. When the value of the discriminant equation is a positive value, it is determined that the partial image belongs to the specific scene, and the sub-partial identifying section 61 increments a positive count value. When the value of the discriminant equation is a negative value, it is determined that the partial image does not belong to the specific scene, and the sub-partial identifying section 61 increments a negative count value.

Next, the sub-partial identifying section 61 determines whether or not the positive count value is larger than the positive threshold (S305). The positive count value indicates the number of partial images that have been determined to belong to the specific scene. When the positive count value is larger than the positive threshold (“YES” in S305), the sub-partial identifying section 61 determines that the image to be identified belongs to the specific scene, and sets a positive flag (S306). In this case, the partial identifying section 60 terminates the partial identification processing without performing identification by the subsequent sub-partial identifying sections 61. For example, when the image to be identified can be identified as an evening scene image, the partial identifying section 60 terminates the partial identification processing without performing identification with respect to flower and autumnal. In this case, the speed of the partial identification processing can be increased because identification by the subsequent sub-identifying sections 61 is omitted.

When the positive count value is not larger than the positive threshold (“NO” in S305), the sub-partial identifying section 61 cannot determine that the image to be identified belongs to the specific scene, and performs the process of the subsequent step S307.

When the sum of the positive count value and the number of remaining partial images is smaller than the positive threshold (“YES” in S307), the sub-partial identifying section 61 proceeds to the process of S309. When the sum of the positive count value and the number of remaining partial images is smaller than the positive threshold, it is impossible for the positive count value to be larger than the positive threshold even when the positive count value is incremented by all of the remaining partial images, so that identification using the support vector machine with respect to the remaining partial images is omitted by advancing the process to S309. As a result, the speed of the partial identification processing can be increased.

When the sub-partial identifying section 61 determines “NO” in S307, the sub-partial identifying section 61 determines whether or not there is a subsequent partial image (S308). In the present embodiment, not all of the 64 partial images into which the image to be identified is divided are selected sequentially. Only the top-ten partial images outlined by bold lines in FIG. 18 are selected sequentially. For this reason, when identification of the tenth partial image is finished, the sub-partial identifying section 61 determines in S308 that there is no subsequent partial image. (With consideration given to this point, “the number of remaining partial images” is also determined.)

FIG. 19 shows graphs of Recall and Precision at the time when identification of an evening scene image was performed based on only the top-ten partial images. When the positive threshold is set as shown in this diagram, the precision ratio (Precision) can be set to about 80% and the recall ratio (Recall) can be set to about 90%, so that identification can be performed with high precision.

In the present embodiment, identification of the evening scene image is performed based on only ten partial images. Accordingly, in the present embodiment, the speed of the partial identification processing can be higher than in the case of performing identification of the evening scene image using all of the 64 partial images.

Moreover, in the present embodiment, identification of the evening scene image is performed using the top-ten partial images with high existence probabilities of an evening scene portion image. Accordingly, in the present embodiment, both Recall and Precision can be set to higher levels than in the case of performing identification of the evening scene image using ten partial images that have been extracted regardless of the existence probability.

Furthermore, in the present embodiment, partial images are selected in descending order of the existence probability of an evening scene portion image. As a result, it is more likely to be determined “YES” at an early stage in S305. Accordingly, the speed of the partial identification processing can be higher than in the case of selecting partial images in the order regardless of the degree of the existence probability.

When it is determined “YES” in S307 or when it is determined in S308 that there is no subsequent partial image, the sub-partial identifying section 61 determines whether or not the negative count value is larger than a negative threshold (S309). This negative threshold has almost the same function as the negative threshold (S206 in FIG. 10) in the above-described overall identification processing, and thus a detailed description thereof is omitted. When it is determined “YES” in S309, a negative flag is set as in the case of S207 in FIG. 10.

When it is “NO” in S302, when it is “NO” in S309, or when the process of S310 is finished, the partial identifying section 60 determines whether or not there is a subsequent sub-partial identifying section 61 (S311). When the processing by the evening scene partial identifying section 61S has been finished, there are remaining sub-partial identifying sections 61, i.e., the flower partial identifying section 61F and the autumnal partial identifying section 61R, so that the partial identifying section 60 determines in S311 that there is a subsequent sub-partial identifying section 61.

Then, when the process of S306 is finished (when it is determined that the image to be identified belongs to a specific scene) or when it is determined in S311 that there is no subsequent sub-partial identifying section 61 (when it cannot be determined that the image to be identified belongs to a specific scene), the partial identifying section 60 terminates the partial identification processing.

As already described above, when the partial identification processing is terminated, the scene identification section 33 determines whether or not scene identification can be accomplished by the partial identification processing (S106 in FIG. 8). At this time, the scene identification section 33 references the identification target table shown in FIG. 11 and determines whether or not there is 1 in the “positive” field.

When scene identification can be accomplished by the partial identification processing (“YES” in S106), the integrative identification processing is omitted. As a result, the speed of the scene identification processing is increased.

Support Vector Machine

Before describing the integrative identification processing, the support vector machine (SVM) used by the sub-identifying sections 51 in the overall identification processing and the sub-partial identifying sections 61 in the partial identification processing is described.

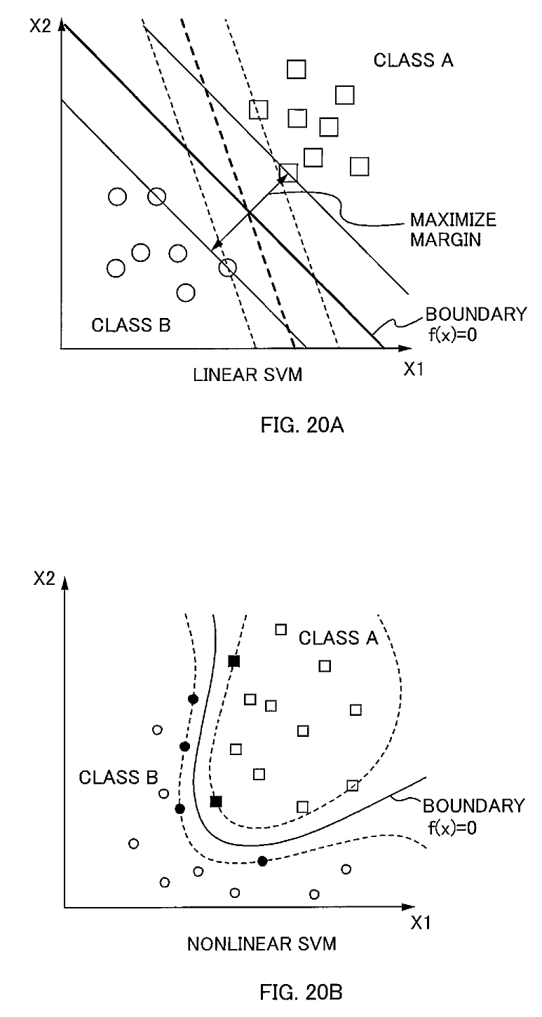

FIG. 20A is an explanatory diagram of discrimination by a linear support vector machine. Here, learning samples are shown in a two-dimensional space defined by two characteristic amounts x1 and x2. The learning samples are divided into two classes A and B. In the diagram, the samples belonging to the class A are represented by circles, and the samples belonging to the class B are represented by squares.

As a result of learning using the learning samples, a boundary that divides the two-dimensional space into two portions is defined. The boundary is defined as <w·x>+b=0 (where x=(x1, x2), w represents a weight vector, and <w·x> represents an inner product of w and x). However, the boundary is defined as a result of learning using the learning samples so as to maximize the margin. That is to say, in this diagram, the boundary is not the bold dotted line but the bold solid line.

Discrimination is performed using a discriminant equation f(x)=<w·x>+b. When a certain input x (this input x is separate from the learning samples) satisfies f(x)>0, it is determined that the input x belongs to the class A, and when f(x)<0, it is determined that the input x belongs to the class B.

Here, discrimination is described using the two-dimensional space. However, this is not intended to be limiting (i.e., more than two characteristic amounts may be used). In this case, the boundary is defined as a hyperplane.

There are cases where separation between the two classes cannot be achieved by using a linear function. In such cases, when discrimination with a linear support vector machine is performed, the precision of the discrimination result decreases. To address this problem, the characteristic amounts in the input space are nonlinearly transformed, or in other words, nonlinearly mapped from the input space into a certain feature space, and thus separation in the feature space can be achieved by using a linear function. A nonlinear support vector machine uses this method.

FIG. 20B is an explanatory diagram of discrimination using a kernel function. Here, learning samples are shown in a two-dimensional space defined by two characteristic amounts x1 and x2. When a nonlinear mapping from the input space shown in FIG. 20B is a feature space as shown in FIG. 20A, separation between the two classes can be achieved by using a linear function. When a boundary is defined so as to maximize the margin in this feature space, an inverse mapping of the boundary in the feature space is the boundary shown in FIG. 20B. As a result, the boundary is nonlinear as shown in FIG. 20B.

Since the Gaussian kernel is used in the present embodiment, the discriminant equation f(x) is expressed by the following formula:

$$f ( x ) = {\sum }_{i}^{N} {w}_{i} exp ( - {\sum }_{j}^{M} \frac{{( {x}_{j} - {y}_{j} )}^{2}}{2 {σ}^{2}} ) \qquad Formula 1$$

where M represents the number of characteristic amounts, N represents the number of learning samples (or the number of learning samples that contribute to the boundary), wᵢ represents a weight factor, yⱼ represents the characteristic amount of the learning samples, and xⱼ represents the characteristic amount of an input x.

When a certain input x (this input x is separate from the learning samples) satisfies f(x)>0, it is determined that the input x belongs to the class A, and when f(x)<0, it is determined that the input x belongs to the class B. Moreover, the larger the value of the discriminant equation f(x) is, the higher the probability that the input x (this input x is separate from the learning samples) belongs to the class A is. Conversely, the smaller the value of the discriminant equation f(x) is, the lower the probability that the input x (this input x is separate from the learning samples) belongs to the class A is. The sub-identifying sections 51 in the overall identification processing and the sub-partial identifying sections 61 in the partial identification processing, which are described above, employ the value of the discriminant equation f(x) of the above-described support vector machine.

It should be noted that evaluation samples are prepared separately from the learning samples. The above-described graphs of Recall and Precision are based on the identification result with respect to the evaluation samples.

Regarding Characteristic Amounts Used in this Embodiment

As described above, the user can set a shooting mode using the mode setting dial 2A. Then, the digital still camera 2 determines shooting conditions (exposure time, ISO sensitivity, etc.) based on, for example, the set shooting mode and the result of photometry when taking a picture and photographs the subject on the determined shooting conditions. After taking a picture, the digital still camera 2 stores shooting data indicating the shooting conditions when the picture was taken in conjunction with image data in the memory card 6 as an image file.

There are instances where the user forgets to set the shooting mode and thus a picture is taken while a shooting mode unsuitable for the shooting conditions remains set. For example, a daytime scene may be photographed while the night scene mode remains set. As a result, in this case, although the image data in the image file is an image of the daytime scene, data indicating the night scene mode is stored in the shooting data (for example, the scene capture type data shown in FIG. 5 is set to “3”).

If the scene capture type data and the shooting mode data are taken as the characteristic amounts, when the user has forgotten to set the shooting mode, the probability of misidentification of that image becomes high. In this case, in respect to the image that has been taken with an unsuitable shooting mode, correction is performed further based on the misidentification result, and there is a possibility that the correction result is poor quality.

Thus, in this embodiment, even if scene information (scene capture type data and shooting mode data) is included in the supplemental data, this scene information is not extracted as characteristic amounts. That is, in this embodiment, the characteristic amounts obtained based on image data and supplemental data other than the scene information are considered as the characteristic amounts. Note that, in the case where supplemental data other than the scene information are characteristic amounts, a variety of shooting data such as Exposure time, F number, Shutter Speed Value, Aperture Value, Exposure Bias Value, Max Aperture Value, Subject Distance, Metering Mode, Light Source, Flash, and White Balance can be considered as the characteristic amounts.

If, of the above supplemental data other than the scene information, control data showing control contents of a digital still camera is taken as a characteristic amount, it becomes possible to decrease the probability of misidentification. This is because, an image quality of the image data differs according to control of the digital still camera, so that if identification processing is performed with the control data as the characteristic amount, the image quality is identified by taking into consideration the control contents of the digital still camera when taking a picture. As the control data of the digital still camera, there are included, for example, data indicating operations of the digital still camera when taking a picture (for example, aperture value, shutter speed, and the like), and data indicating image processing of the digital still camera after taking a picture (for example, white balance, and the like).

If, of the control data, in particular control data relating to brightness is taken as the characteristic amount, it becomes possible to decrease the probability of misidentification. As control data relating to brightness, there are included, for example, aperture value, shutter speed, ISO sensitivity, and the like. That is, the control data relating to brightness is, in other words, data relating to a light amount that enters a CCD of the digital still camera.

When identifying two images that are dark to a similar degree, if the identification processing is performed without the control data relating to brightness of the image as the characteristic amount, both images may be identified as a “night scene”, for example. However, for example, if shutter speed is taken as the characteristic amount, it is possible to perform identification by considering if it is a dark image regardless of the shutter speed being long, or if it is a dark image due to the shutter speed being short. In the case of a dark image due to backlight, the shutter speed is short, therefore if the shutter speed is taken as the characteristic amount, it is possible to decrease the probability of misidentification of the dark image due to backlight as a “night scene”.

Further, it becomes possible to decrease the probability of misidentification, if, of the control data, the control data relating to the color of the image is taken as the characteristic amount. As the control data relating to the color of the image, for example, there is included white balance, and the like.

If, when identifying two images with strong redness of a similar degree, the identification processing is performed without data relating to the color of the image as the characteristic amount, both images may be identified as for example, an “evening scene”. However, if white balance is taken as the characteristic amount for example, then it is possible to perform identification by consideration if the image has a strong redness due to image processing that emphasizes the red, or if the image has a strong redness regardless that image processing that emphasizes the red is not performed. If the latter image becomes less likely to be identified as an “evening scene” than the former image by taking the white balance as the characteristic amount, then it becomes possible to decrease the probability of misidentification.

As the supplemental data used as the characteristic amounts, there are data that indicates continuous values and data that indicates discrete values. For example, in the case where the supplemental data indicates physical amounts, such as the shutter speed and the aperture value, the data indicates continuous values. On the other hand, in the case where the supplemental data indicates ON/OFF of photometry modes and flash, the data shows discrete values. In either of these cases, it is possible to use values shown by the supplemental data as a characteristic amount yⱼ (a characteristic amount of a learning samples) and a characteristic amount xⱼ (a characteristic amount of input x) of the above-described discriminant equation f(x).

In this embodiment, a characteristic amount is obtained from the learning samples, and a discriminant equation is obtained using the characteristic amount. The obtained discriminant equation is combined in a part of a program for structuring sub-identifying sections 51 and sub-partial identifying sections 61. When identifying a scene belonging to an image to be identified, the characteristic amount is obtained from the image file, the value of the discriminant equation is calculated, and identification is performed based on the value of this discriminant equation.

It should be noted that in order to increase the accuracy rate even if there is a dial setting mistake, with the scene information taken as the characteristic amount, it is necessary to prepare a learning samples including a dial setting mistake. However, it is difficult to prepare such learning samples, and even if it can be prepared, the number of learning samples will increase. Further, a calculation amount of the discriminant equation increases when the number of learning samples increases, and the processing speed of the identifying section decreases. In view of the above, it is preferable that the scene information is not taken as the characteristic amount.

According to this embodiment, the probability of misidentification of the image to be identified can be decreased. Further, the image shot when the user has forgotten to set the shooting mode is taken with an unsuitable shooting mode, so that the effect is large when it is suitably identified and suitably corrected.

Integrative Identification Processing

In the above-described overall identification processing and partial identification processing, the positive threshold in the sub-identifying sections 51 and the sub-partial identifying sections 61 is set to a relatively high value to set Precision (accuracy rate) to a rather high level. The reason for this is that when, for example, the accuracy rate of the landscape identifying section 51L of the overall identification section is set to a low level, a problem occurs in that the landscape identifying section 51L misidentifies an autumnal image as a landscape image and terminates the overall identification processing before identification by the autumnal identifying section 51R is performed. In the present embodiment, Precision (accuracy rate) is set to a rather high level, and thus an image belonging to a specific scene is identified by the sub-identifying section 51 (or the sub-partial identifying section 61) with respect to that specific scene (for example, an autumnal image is identified by the autumnal identifying section 51R (or the autumnal partial identifying section 61R)).

However, when Precision (accuracy rate) of the overall identification processing and the partial identification processing is set to a rather high level, the possibility that scene identification cannot be accomplished by the overall identification processing and the partial identification processing increases. To address this problem, in the present embodiment, when scene identification could not be accomplished by the overall identification processing and the partial identification processing, the integrative identification processing described in the following is performed.

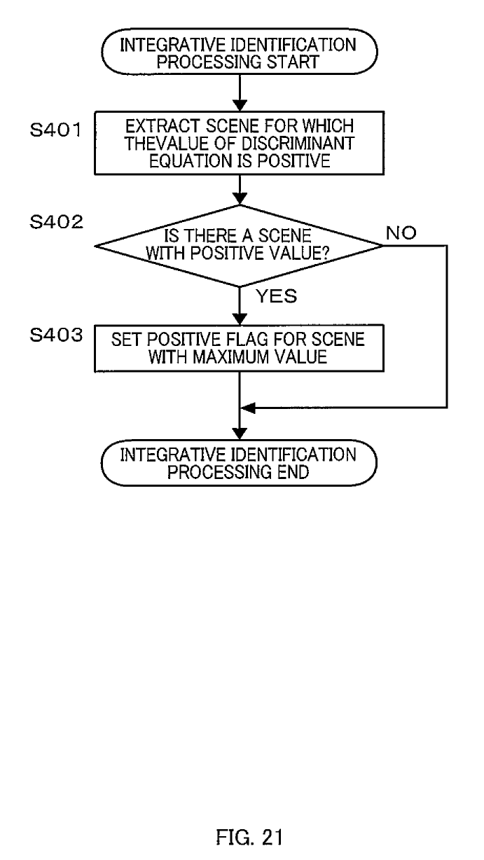

FIG. 21 is a flow diagram of the integrative identification processing. As described in the following, the integrative identification processing is processing for selecting a scene with the highest certainty factor based on the value of the discriminant equation of each sub-identifying section 51 in the overall identification processing.

First, the integrative identifying section 70 extracts, based on the values of the discriminant equations of the five sub-identifying sections 51, a scene for which the value of the discriminant equation is positive (S401). At this time, the value of the discriminant equation calculated by each of the sub-identifying sections 51 during the overall identification processing is used.

Next, the integrative identifying section 70 determines whether or not there is a scene for which the value of the discriminant equation is positive (S402).

When there is a scene for which the value of the discriminant equation is positive (“YES” in S402), a positive flag is set under the column of a scene with the maximum value (S403), and the integrative identification processing is terminated. Thus, it is determined that the image to be identified belongs to the scene with the maximum value.

On the other hand, when there is no scene for which the value of the discriminant equation is positive (“NO” in S402), the integrative identification processing is terminated without setting a positive flag. Thus, there is still no scene for which 1 is set in the “positive” field of the identification target table shown in FIG. 11. That is to say, which scene the image to be identified belongs to could not be identified.

As already described above, when the integrative identification processing is terminated, the scene identification section 33 determines whether or not scene identification can be accomplished by the integrative identification processing (S108 in FIG. 8). At this time, the scene identification section 33 references the identification target table shown in FIG. 11 and determines whether or not there is 1 in the “positive” field. When it is determined “NO” in S402, it is also determined “NO” in S108.

### Other Embodiments

In the foregoing, an embodiment was described using, for example, the printer. However, the foregoing embodiment is for the purpose of elucidating the present invention and is not to be interpreted as limiting the present invention. It goes without saying that the present invention can be altered and improved without departing from the gist thereof and includes functional equivalents. In particular, the present invention also includes embodiments described below.

Regarding the Printer

In the above-described embodiment, the printer 4 performs the scene identification processing, and the like. However, it is also possible that the digital still camera 2 performs the scene identification processing, and the like. Moreover, the information processing apparatus that performs the above-described scene identification processing is not limited to the printer 4 and the digital still camera 2. For example, an information processing apparatus such as a photo storage device for retaining a large number of image files may perform the above-described scene identification processing. Naturally, a personal computer or a server located on the Internet may perform the above-described scene identification processing.

Regarding the Image File

The above-described image file was an Exif format file. However, the image file format is not limited to this. Moreover, the above-described image file is a still image file. However, the image file may be a moving image file. In effect, as long as the image file contains the image data and the supplemental data, it is possible to perform scene identification processing as described above.

Regarding the Support Vector Machine

The above-described sub-identifying sections 51 and sub-partial identifying sections 61 employ the identification method using the support vector machine (SVM). However, the method for identifying whether or not the image to be identified belongs to a specific scene is not limited to the method using the support vector machine. For example, it is also possible to employ pattern recognition techniques, such as a neural network.

Summary

(1) In the foregoing embodiment, the printer-side controller 20 calculates the color average, the variance, and the like of the image indicated by the image data from the image data. Further, the printer-side controller 20 obtains the shooting data other than the scene information from the supplemental data appended to the image data. Then, with these obtained data as the characteristic amounts, the printer-side controller 20 performs identification processing such as the overall identification processing and identifies a scene of the image indicated by the image data.

In the above described embodiment, the scene information is not included in the characteristic amount. This is because, if the scene information is taken as the characteristic amount, the probability that the image is misidentified becomes high when the user forgets to set the shooting mode.

(2) In the foregoing embodiment, the control data of the digital still camera (corresponds to a picture-taking apparatus) at the time of taking a picture (corresponds to when generating the image data) is taken as the characteristic amount, and the scene of the image is identified. If identification processing is performed with the control data as the characteristic amount in this way, the image quality can be identified by considering the control contents of the digital still camera at the time of taking a picture. Therefore the probability of misidentification can be decreased.

(3) In the foregoing embodiment, the control data relating to brightness such as an aperture value and shutter speed are taken as the characteristic amounts, and a scene of the image is identified. In this way, even if the images are of a similar degree of brightness, the result of identification may vary. Further, in this way, the probability of misidentification can be decreased.

(4) In the foregoing embodiment, the control data relating to the color of the image such as white balance is taken as a characteristic amount, and a scene of the image is identified. In this way, even if the images are of a similar degree of color, the result of identification may vary. Further, in this way, the probability of misidentification can be decreased.

(5) In the above-described scene identification processing, when scene identification cannot be accomplished by the overall identification processing (“NO” in S105), the partial identification processing is performed (S106). On the other hand, when scene identification can be accomplished by the overall identification processing (“YES” in S105), the partial identification processing is not performed. As a result, the speed of the scene identification processing is increased.

(6) In the above-described overall identification processing, the sub-identifying section 51 calculates the value of the discriminant equation (corresponding to the evaluation value), and when this value is larger than the positive threshold (corresponding to the first threshold) (“YES” in S204), the image to be identified is identified as a specific scene (S205). On the other hand, when the value of the discriminant equation is smaller than the first negative threshold (corresponding to the second threshold) (“YES” in S206), a negative flag is set (S207), and in the partial identification processing, the partial identification processing with respect to that specific scene is omitted (S302).

For example, during the overall identification processing, when the value of the discriminant equation of the evening scene identifying section 51S is smaller than the first negative threshold (“YES” in S206), the probability that the image to be identified is an evening scene image is already low, so that there is no point in using the evening scene partial identifying section 61S during the partial identification processing. Thus, during the overall identification processing, when the value of the discriminant equation of the evening scene identifying section 51S is smaller than the first negative threshold (“YES” in 5206), the “negative” field under the “evening scene” column in FIG. 11 is set to 1 (S207), and processing by the evening scene partial identifying section 61S is omitted (“NO” in S302) during the partial identification processing. As a result, the speed of the scene identification processing is increased (see also FIG. 16A and FIG. 16B).

(7) In the above-described overall identification processing, identification processing using the landscape identifying section 51L (corresponding to the first scene identification step) and identification processing using the night scene identifying section 51N (corresponding to the second scene identification step) are performed.

A high probability that a certain image belongs to landscape scenes inevitably means a low probability that the image belongs to night scenes. Therefore, when the value of the discriminant equation (corresponding to the evaluation value) of the landscape identifying section L is large, it may be possible to identify the image as not being a night scene.

Thus, in the foregoing embodiment, the second negative threshold (corresponding to the third threshold) is provided (see FIG. 16B). When the value of the discriminant equation of the landscape identifying section 51L is larger than the negative threshold (−0.44) for night scenes (“YES” at S206), the “negative” field under the “night scene” column in FIG. 11 is set to 1 (S207), and processing by the night scene identifying section 51N is omitted (“No” in S202) during the overall identification processing. As a result, the speed of the scene identification processing is increased.

(8) The above-described printer 4 (corresponding to the information processing apparatus) includes the printer-side controller 20 (see FIG. 2). The printer-side controller 20 calculates the color average and the variance of the image indicated by the image data from the image data. Further, the printer-side controller 20 obtains shooting data other than the scene information from the supplemental data appended to the image data. With these obtained data as the characteristic amounts, the printer-side controller 20 performs identification processing such as the overall identification processing, and identifies a scene of the image indicated by the image data.

In this way, identification processing is performed without the scene information as the characteristic amount, so that even if the user forgets to set the shooting mode, the probability of misidentification can be decreased.

(9) The above-described memory 23 has a program stored therein, which makes the printer 4 execute the processes shown in FIG. 8. That is to say, this program has code for obtaining data indicating the characteristic of the image indicated by the image data from the image data, code for obtaining data other than data relating to a scene from the supplemental data appended to the image data, and code for identify the scene of the image indicated by the image data with the obtained data as the characteristic amount.

According to such a program, the probability of misidentification of the information processing apparatus can be decreased.

Although the preferred embodiment of the present invention has been described in detail, it should be understood that various changes, substitutions and alterations can be made therein without departing from spirit and scope of the inventions as defined by the appended claims.

What is claimed is:

1. An information processing method comprising:
obtaining, from image data, data indicating a characteristic of an image indicated by the image data;
obtaining, from supplemental data appended to the image data, data other than data relating to a scene; and
identifying a scene of the image with data indicating the characteristic of the image and the data other than data relating to the scene as characteristic amounts.

2. An information processing method according to claim 1,
wherein the data other than data relating to the scene is control data of a picture-taking apparatus when generating the image data.

3. An information processing method according to claim 2,
wherein the control data is data relating to brightness of the image.

4. An information processing method according to claim 2,
wherein the control data is data relating to a color of the image.

5. An information processing method according to claim 1,
wherein obtaining data indicating the characteristic of the image includes acquiring data indicating the characteristic of the entire image and data indicating characteristics of partial images included in the image,
identifying the scene includes
entire identification of identifying the scene of the image indicated by the image data, using data indicating the characteristic of the entire image, and
partial identification of identifying the scene of the image indicated by the image data, using data indicating the characteristics of the partial images,
wherein when the scene of the image cannot be identified in the entire identification, the partial identification is performed, and
when the scene of the image can be identified in the entire identification, the partial identification is not performed.

6. An information processing method according to claim 5,
wherein the entire identification includes
calculating an evaluation value according to a probability that the image is a predetermined scene, using data indicating the characteristic of the entire image, and
when the evaluation value is larger than a first threshold, identifying the image as the predetermined scene,
wherein the partial identification includes identifying the image as the predetermined scene, using data indicating the characteristics of the partial images, and
wherein when the evaluation value in the entire identification is smaller than a second threshold, the partial identification is not performed.

7. An information processing method according to claim 1,
wherein identifying the scene includes
a first scene identification of identifying that the image is a first scene based on the characteristic amounts, and
a second scene identification of identifying that the image is a second scene different from the first scene based on the characteristic amounts,
wherein the first scene identification includes
calculating an evaluation value according to a probability that the image is the first scene based on the characteristic amounts, and
when the evaluation value is larger than a first threshold, identifying the image as the first scene,
wherein in identifying the scene,
when the evaluation value in the first identification is larger than a third threshold, the second scene identification is not performed.

8. An information processing apparatus comprising:
a first obtaining section that obtains, from image data, data indicating a characteristic of an image indicated by the image data;
a second obtaining section that obtains, from supplemental data appended to the image data, data other than data relating to a scene; and
an identifying section that identifies the scene of the image with data indicating the characteristic of the image and the data other than data relating to the scene as characteristic amounts.

9. A storage medium having a program stored thereon, the program comprising:
a first program code that makes an information processing apparatus obtain, from image data, data indicating a characteristic of an image indicated by the image data;
a second program code that makes an information processing apparatus obtain, from supplemental data appended to image data, data other than data relating to a scene; and
a third program code that makes an information processing device identify a scene of the image with data indicating a characteristic of the image and the data other than data relating to the scene as characteristic amounts.
